(19) United States
(12) Patent Application Publication
(10) Pub. No.: US 2009/0156263 A1
(43) Pub. Date: Jun. 18, 2009

(54) PORTABLE TERMINAL HAVING RETRACTABLE SPEAKER

(75) Inventors: Hae Sung Park, Suwon-si (KR); Hong Bae Kim, Yongin-si (KR); Jong Cheon Wee, Yongin-si (KR); Sang Hyuck Jung, Hwaseong-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/332,035

(22) Filed: Dec. 10, 2008

(30) Foreign Application Priority Data
Dec. 17, 2007 (KR) 10-2007-0132418

(51) Int. Cl. H04M 1/00

(52) U.S. Cl. 455/566; 455/575.3; 455/575.4

(57) ABSTRACT

The present invention relates to a portable terminal having retractable speakers that can be used by extending outwards to both sides of the portable terminal. The portable terminal includes a main body, at least one speaker, and a hinge unit. The main body has at least one display unit arranged on a first surface of the main body and a recess formed on a second surface of the main body opposite to the first surface. The speaker is retracted into the recess. The hinge unit is arranged at an edge of the recess to connect the speaker to the main body, to extend the speaker outwards from the recess, and to retract the speaker into the recess. The speaker outputs a sound outwards from the first surface of the main body when extended. The slope angle of the speaker can be adjusted by rotating the speaker about an axis of the hinge unit when extended.

### CROSS REFERENCE TO RELATED APPLICATION

This application claims priority from and the benefit of Korean Patent Application No. 10-2007-0132418, filed on Dec. 17, 2007, which is hereby incorporated by reference for all purposes as if fully set forth herein.

### BACKGROUND OF THE INVENTION

1. Field of the Invention

The present invention relates to a portable terminal, and more particularly, to a portable terminal having a retractable speaker whose angle can be adjusted when the speaker is extended.

2. Discussion of the Background

Portable terminals are very popular and widely used. Because of rapid development in information telecommunication technology and mobile communication technology, portable terminals provide video communication function, MP3 function, and video play function, in addition to wireless communication function, and the performance of portable terminals is rapidly improving. Accordingly, sound quality and an acoustic effect of a speaker are very important factors to support the various functions of portable terminals.

A speaker may be formed with a magnet, coil, and vibrator. When an electric current flows through the coil in a magnetic field generated by the magnet, a Lorentz force is generated. The coil activates the vibrator with this force, and a sound wave is generated by vibration of the air contacting the vibrator. The speaker may have an acoustic resonance space to secure a better performance of the speaker.

However, it is difficult to obtain a 3-dimensional sound effect and a high quality sound with only one speaker, even when a high performance speaker is used. To solve this problem, portable terminals with two speakers installed in a main body have been developed to provide stereo sound.

However, speakers installed in stereo sound portable terminals may be arranged at side surfaces of the portable terminal, and a display unit may be installed at the front surface of the portable terminal. Therefore, sounds are output to the side surfaces, while a video communication, game, or video play function is used through the front surface display unit of the portable terminal. Therefore, a user may be limited in listening to a high quality sound or a stereo sound through the two speakers installed in the conventional portable terminal.

### SUMMARY OF THE INVENTION

The present invention provides a portable terminal having a retractable speaker that outputs a sound towards the front side of a display unit installed in the portable terminal.

The present invention also provides a portable terminal having a retractable speaker with which a user can adjust a sound output direction.

Additional features of the invention will be set forth in the description which follows, and in part will be apparent from the description, or may be learned by practice of the invention.

The present invention discloses a portable terminal having a retractable speaker that includes: a main body having at least one display unit arranged on a first surface of the main body and a recess formed at a second surface of the main body; at least one speaker; and a hinge unit to connect the speaker to the main body, and to extend the speaker outwards from the recess and to retract the speaker into the recess, wherein the extended speaker outputs a sound outwards from the first surface of the main body.

The present invention also discloses a portable terminal having a sliding type retractable speaker that has a main body having a display unit arranged on a first surface and recesses arranged at both sides of the main body adjacent to the first surface, and two speakers arranged individually in the recesses to output a sound outwards from the first surface. It also has a hinge unit connected to each speaker to retract the speaker into the recess and to extend the speaker outwards from the recess.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view showing a rear side of a portable terminal having two retractable speakers according to an exemplary embodiment of the present invention.

FIG. 2 is a sectional view cut along line A-A′ of FIG. 1.

FIG. 3 is a perspective view showing a front side of the portable terminal having two retractable speakers of FIG. 1 when both speakers are unfolded.

FIG. 4 is a perspective view showing the front side of the portable terminal having two retractable speakers of FIG. 1 when both speakers are unfolded and the slope of the speakers is adjusted to a predetermined angle.

FIG. 5 is a perspective view showing a rear side of a portable terminal having two retractable speakers according to another exemplary embodiment of the present invention.

FIG. 6 is a perspective view showing a front side of the portable terminal having two retractable speakers of FIG. 5 when both speakers are extended outwards.

FIG. 7 is a perspective view showing the front side of the portable terminal having two retractable speakers of FIG. 1 when both speakers are extended outwards and the slope angle of the speakers is adjusted to a predetermined angle.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

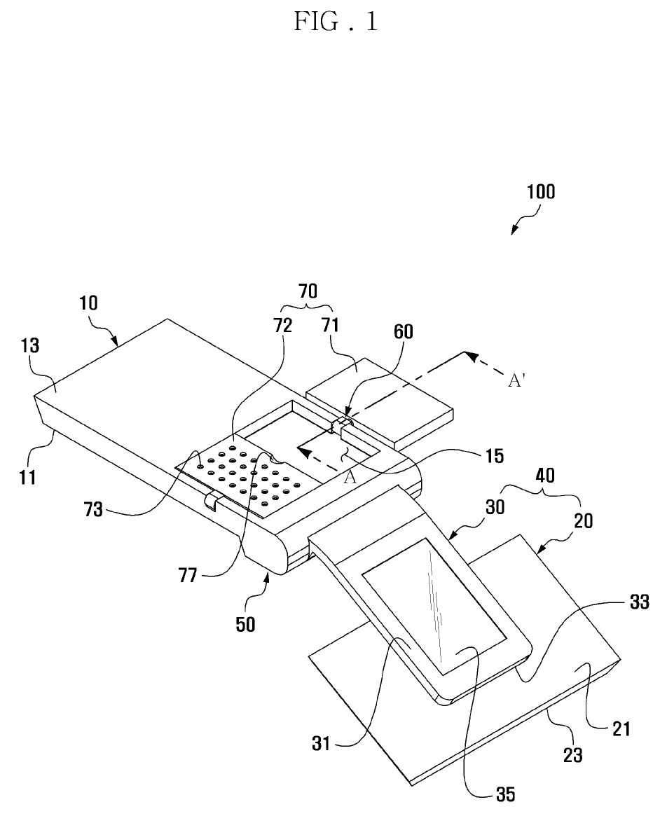

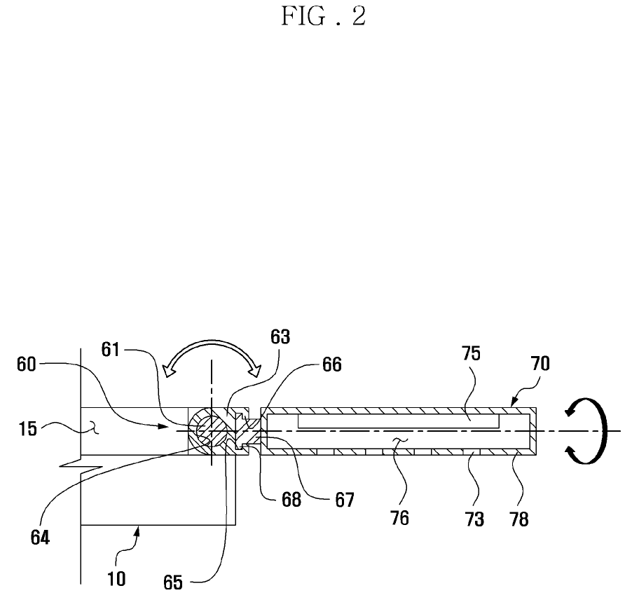

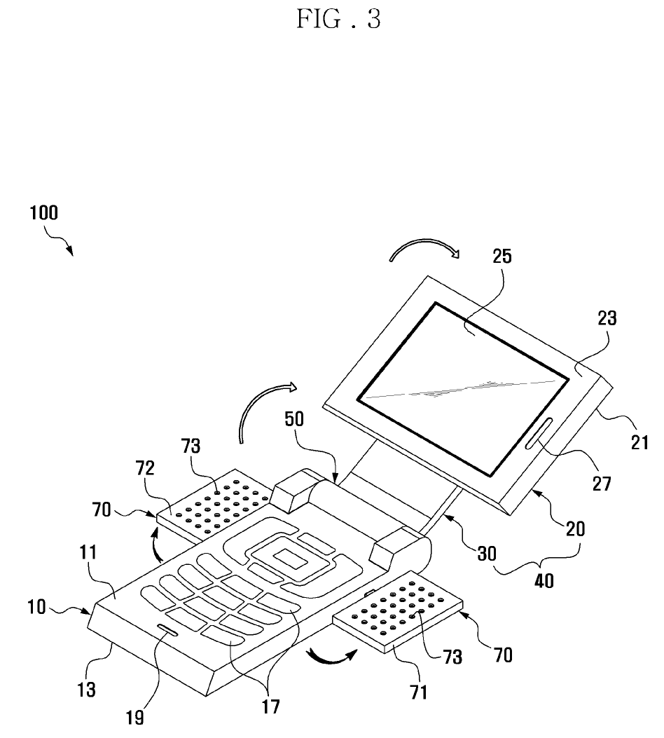

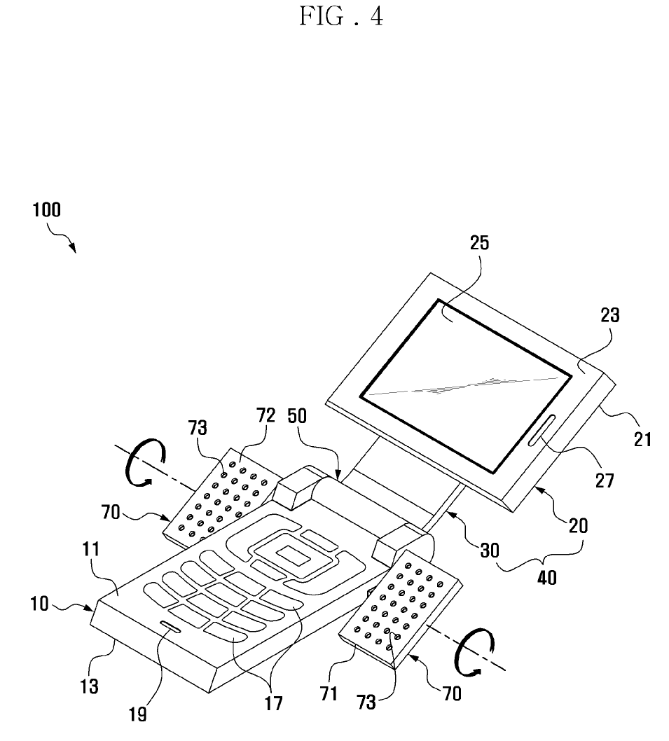

FIG. 1, FIG. 2, FIG. 3, and FIG. 4 show a portable terminal 100 having a retractable speaker 70 according to an exemplary embodiment of the present invention. The portable terminal 100 includes a first main body 10, second main body 40, speaker 70, and first hinge 60. The first main body 10 has a receiving recess 15 formed on its rear surface, and the second main body 40 has at least one of a first display unit 35 and a second display unit 25 on its surfaces. A first hinge unit 60 is installed at an edge of the receiving recess 15 to connect the speaker 70 to the main body 10 such that the speaker 70 may be extended outwards from the receiving recess 15 or retracted into the receiving recess 15. The speaker 70 includes a first speaker 71 and a second speaker 72 that may be retracted into the receiving recess 15. The first hinge unit 60 connects the first speaker 71 and the second speaker 72 to the first main body 10 so that the first speaker 71 and the second speaker 72 may be extended outwards from the receiving recess 15. The extended speaker 70 outputs a sound outwards from a surface of the first and second main bodies 10 and 40.

The portable terminal 100 according to the present exemplary embodiment is a mobile communication terminal, such as a mobile phone or a personal digital assistant (PDA).

The first main body 10 has a main body first surface 11 at the front side thereof and a main body second surface 13 opposite to the main body first surface 11. The receiving recess 15 is formed on the main body second surface 13. A second hinge unit 50 is formed at an edge of the first main body 10 to connect the second main body 40 to the first main body 10.

An input unit 17 and a microphone 19 are formed on the main body first surface 11. The input unit 17 may be an input unit such as a keypad, a touchpad, and a joy stick, and the input unit 17 generates an input signal according to a user's operation. The microphone 19 generates a voice signal from an input voice communication.

The second main body 40 includes a connecting part 30 and a swiveling part 20. The connecting part 30 is rotatably connected to the first main body 10 through the second hinge unit 50. The connecting part 30 has a connecting part first surface 31 having a first display unit 35, and a connecting part second surface 33 opposite to the connecting part first surface 31 and facing the main body first surface 11. The swiveling part 20 is rotatably connected to the connecting part second surface 33 through a rotating hinge unit (not shown). The swiveling part 20 has a swiveling part first surface 21 facing the connecting part second surface 33, and a swiveling part second surface 23 opposite to the swiveling part first surface 21 and having a second display unit 25.

The first display unit 35 and the second display unit 25 may be a liquid crystal display (LCD) or an active matrix organic light emitting diode (AM OLED) display unit. The first display unit 35 and the second display unit 25 visually output information that may be provided to a user.

The swiveling part 20 has a receiving speaker 27 formed in an area adjacent to a shorter edge of the second display unit 25. The receiving speaker 27 is an integrated speaker outputting a voice of a communicating party in a voice communication. When the speaker 70 is activated to output a sound, the receiving speaker 27 may also be activated to provide a better sound effect to the user.

The swiveling part first surface 21 may be formed so that a portion thereof is overlapped with the connecting part second surface in a predetermined area. A rotating third hinge unit (not shown) is disposed in the area where the swiveling part 20 and the connecting part 30 are overlapped, and thereby the swiveling part 20 may rotate to a predetermined angle about the rotating third hinge unit to provide a landscape display mode.

Because the swiveling part 20 is fixed to the connecting part 30, when the connecting part 30 rotates about the second hinge 50 of the first main body 10, the swiveling part 20 and the connecting part 30 rotate together around the rotational axis of the second hinge 50. The first main body 10 and the swiveling part 20 may be formed adjacent to each other or maintaining a distance from each other about the second hinge 50.

The speaker 70 includes the first speaker 71 and second speaker 72, and the first speaker 71 and the second speaker 72 may be retracted into the receiving recess 15 or extended from the receiving recess symmetrically. The first speaker 71 and second speaker 72 each include a case 78 and a sound output unit 75. The case 78 has a resonance room 76 and a plurality of sound emission holes 73 facing outwards from the main body second surface 13, when the speaker is retracted into the receiving recess 15. The sound emission hole 73 may be formed in various shapes, and may be disposed in a uniform grid-like or radial pattern. The sound output unit 75 is formed in the resonance room 76 of the case 78 so that a sound may be output through the sound emission holes 73. A cutout portion 77 is formed in at least one of the first speaker 71 and the second speaker 72 such that the first speaker 71 and the second speaker 72 may be extended outwards from the retracted position in the receiving recess 15.

The first hinge 60 includes a first hinge shaft 61, a hinge body 63, and a second hinge shaft 67. The first hinge shaft 61 is formed at an edge of the receiving recess 15. One end of the hinge body 63 is connected to the speaker 70 at the second hinge shaft 67, and the other end of the hinge body 63 is rotatably connected to the first hinge shaft 61. One end of the second hinge shaft 67 is attached to the speaker 70, and the other end of the second hinge shaft 67 is rotatably connected to the hinge body 63 so that the extended speaker 70 can rotate relative to hinge body 63.

A hinge hole 64 is formed in the hinge body 63 for mounting the first hinge shaft 61, and a hinge recess 65 is formed on a surface of the hinge body 63 parallel to the direction of the hinge hole 64 for mounting the second hinge shaft 67, so that the second hinge shaft 67 rotates in an axis perpendicular to that of the first hinge shaft 61. The first hinge shaft 61 is rotatably connected to the hinge hole 64, and the second hinge shaft 67 is rotatably connected to the hinge recess 65.

A protrusion 68 may be formed at the end of the second hinge shaft 67 rotating within the hinge groove 65 and a locking member 66 is formed at an open end of the hinge recess 65 of the hinge body 63, in order to enable the second hinge shaft 67 to rotate while preventing the second hinge shaft 76 from leaving the hinge recess 65. The shape and detailed structure of the first hinge 60 may differ according to various design factors. For example, the second hinge shaft 67 may be rotatably connected to the hinge body 63 and the second hinge shaft 67 is fixed to the speaker 70. Alternatively, the second hinge shaft 67 may be rotatably connected to the speaker 70, and the second hinge shaft 67 may be fixed to the hinge body 63.

The speaker 70 may be retracted into the receiving recess 15 and extended outwards from the receiving recess 15 by rotating about the first hinge shaft 61. The speaker 70 can rotate through 180 degrees about the first hinge shaft 61. Further, a function of the speaker 70 may be switched on and off by extending the speaker 70 from the receiving recess 15, and by retracting the speaker 70 into the receiving recess 15, respectively.

The speaker 70 may rotate about the second hinge shaft 67 when the speaker 70 is extended outwards from the receiving recess 15. Because the second hinge shaft 67 is attached to the speaker 70, the second hinge shaft 67 and the speaker 70 rotate together through the hinge recess 65 of the hinge body 63.

The speaker 70 of the portable terminal 100, according to the present exemplary embodiment, may rotate through 180 degrees about the first hinge shaft 61, and can rotate about the second hinge shaft 67 in an axis perpendicular to that of the first hinge shaft 61. Therefore, a slope angle of the speaker 70 may be adjusted.

In the present exemplary embodiment, the retractable speaker 70 is formed in the first main body 10 of the swiveling type portable terminal 100. However, the retractable speaker may also be formed in a main body of a bar type, folder type, slide type, or flip type portable terminal.

As described above, the speaker 70 can be used by being extended outwards to both sides of the first main body 10 and adjusting the slope angle of the speaker 70, as shown in FIG. 3 and FIG. 4. FIG. 3 shows the speaker 70 extended outwards to both sides of the first main body 10, and FIG. 4 shows the speaker 70 extended outwards to both sides of the first main body 10 and the slope angle of the speaker 70 adjusted to a predetermined angle.

As shown in FIG. 3, in the portable terminal 100 having the first main body 10 and the second main body 40 connected to each other, the input unit 17 and the second display unit 25 may be exposed by rotating the second main body 40 about the second hinge 50 outwards from the first main body 10.

The swiveling part 20 may rotate through an angle of 90 degrees relative to the connecting part 30, so that the second display unit 25 may be arranged in a landscape format orientation.

The first speaker 71 and the second speaker 72 are arranged at opposite sides of the first main body 10, after extending outwards from the receiving recess 15. The sound emission holes 73 may be positioned in the front side of the first speaker 71 and the second speaker 72, and face in the same direction as the input unit 17 of the first main body 10. Because the first speaker 71 and the second speaker 72 maintain a predetermined distance from each other, sounds may be output by the speakers 71 and 72 without interfering with each other.

As shown in FIG. 4, an output direction of a sound may be adjusted by adjusting the angles of the first speaker 71 and second speaker 72 extended to both sides of the first main body 10. For example, the output direction of sounds and a display direction may be adjusted to be in the same direction by arranging the first speaker 71, the second speaker 72, and the second display unit 25 on a plane.

Accordingly, a user may enjoy a stereo sound output by the first speaker 71 and the second speaker 72 extended to both sides of the first main body 10, for example when watching a moving picture through the second display unit 25, or playing a game through the second display unit 25 and the input unit 17.

That is, the speaker 70 of the portable terminal 100 according to the present exemplary embodiment may be retracted into the first main body 10 when not in use, and may be extended to both sides of the first main body 10 when in use, so that the extended speaker 70 faces outwards from the main body first surface 11 to output a sound towards the user. Further, the first speaker 71 and second speaker 72 extended outwards from the first main body 10 may each have an independent acoustic resonance structure, and thereby the user may get a better sound quality and acoustic effect. Further, the slope angle of the speaker 70 extended to both sides of the first main body 10 can be adjusted, and thereby the output direction of a sound can be adjusted according to the user's requirement.

In the above described exemplary embodiment, an example in which the portable terminal has a receiving recess formed at a rear surface of a first main body is disclosed. However, in the following exemplary embodiments, the receiving recess may be formed at opposite sides of a first main body.

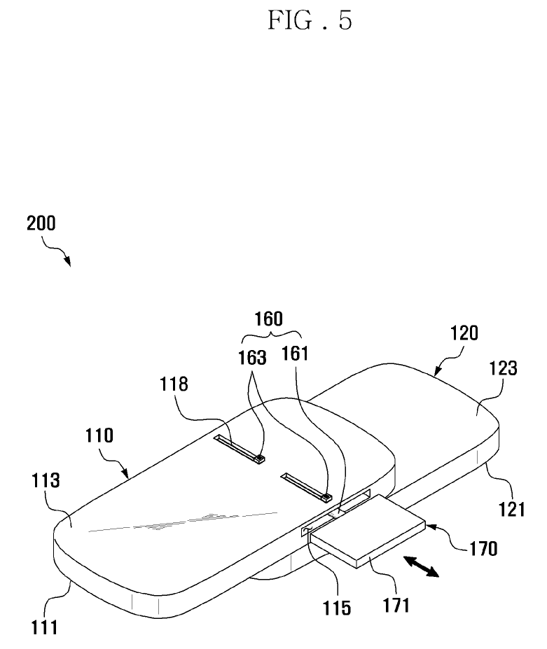

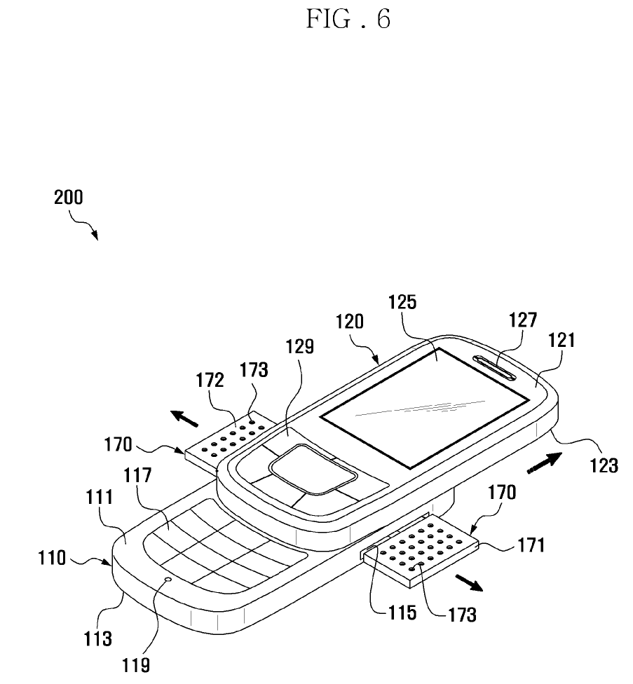

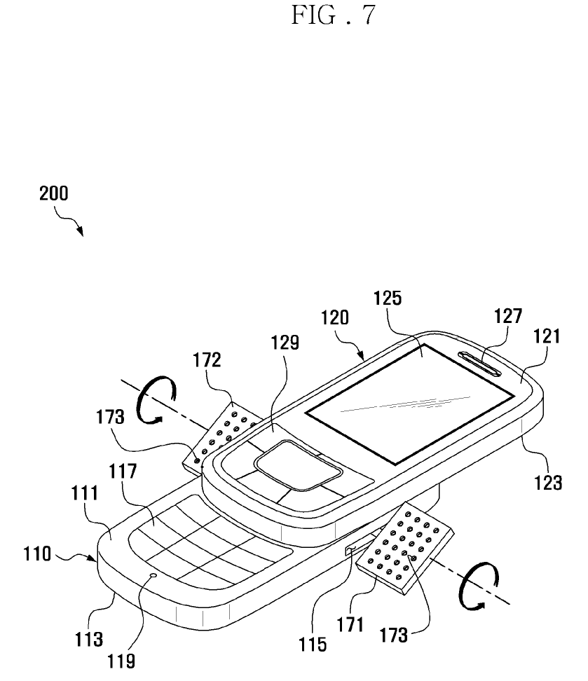

FIG. 5, FIG. 6, and FIG. 7 show a portable terminal 200 having a retractable speaker 170 according to another exemplary embodiment of the present invention. The portable terminal 200 is a slide type portable terminal and includes a first main body 110, second main body 120, speaker 170, and hinge 160.

The first main body 110 and second main body 120 are connected through a slide hinge (not shown).

The first main body 110 has a first main body first surface 111 and a first main body second surface 113 opposite thereto. A receiving recess 115 is formed at both sides of the first main body 110 and between the first main body first surface 111 and the first main body second surface 113 to accommodate the speaker 170. A guide recess 118 is formed on the first main body second surface 113 along the receiving recess 115. An input unit 117 and a microphone 119 are formed on the first main body first surface 111.

The second main body 120 has a second main body first surface 121 and a second main body second surface 123 opposite thereto. The second main body second surface 123 contacts with the first main body first surface 111. The second main body first surface 121 has a direction key 129 and a display unit 125, and has a receiving speaker 127 formed adjacent to an edge of the display unit 125.

The speaker 170 includes a first speaker 171 and a second speaker 172, and is connected to the first main body 110 through a hinge 160 such that the speaker 170 can be retracted into and extended from the receiving recess 115 formed at both sides of the first main body 110. An output direction of a sound may be adjusted by extending the first speaker 171 and the second speaker 172 outwards from the receiving recess 115 to arrange them at both sides of the first main body 110, and by adjusting the slope angles of the first speaker 171 and the second speaker 172. Further, sounds can be output by the first speaker 171 and the second speaker 172 without interfering with each other, because the first speaker 171 and the second speaker 172 maintain a predetermined distance from each other. In this state, the sound emission holes 173 of the speaker 170, extended from the receiving recess 115, face in the same direction as the first main body first surface 111.

The hinge 160 connects the speaker 170 to the first main body 110 such that the speaker 170 can be extended outwards from the receiving recess 115 or retracted into the receiving recess 115. The hinge 160 includes a hinge shaft 161 and a lever 163. An end of the hinge shaft 161 is rotatably connected to the speaker 170. For the connection of the speaker 170 to the hinge shaft 161, the connection structure between the hinge body 63 and the second hinge shaft 67 described in the previous exemplary embodiment may be used, and is therefore not described in detail here. The lever 163 connected to the hinge shaft 161 protrudes outwards from the first main body second surface 113 through the guide groove 118 so that it can be used to extend the speaker outwards from the receiving recess 115 and to retract the speaker 170 into the receiving recess 115. In the present exemplary embodiment, the lever 163 protrudes from the first main body second surface 113. Alternatively, the guide recess 118 may be formed in a stepped form in the first main body second surface 113, and the lever 163 may be formed so that it does not protrude from the first main body second surface 113.

As shown in FIG. 6 and FIG. 7, the speaker 170 of the portable terminal 200 according to the present exemplary embodiment may be used by extending the speaker 170 to both sides of the first main body 110 and adjusting the angle of the speaker 170.

Referring to FIG. 6, in the state that the first main body 110 and the second main body 140 overlap, the input unit 117 is exposed by pushing the second main body 140 upwards against the first main body 110.

The first speaker 171 and the second speaker 172 may be used by extending the speakers 171 and 172 outwards from the receiving recess 115, and arranging them at both sides of the first main body 110. That is, if the lever 163 is pushed to a side of the first main body 110 through the guide recess 118, the speaker 170 retracted in the receiving recess 115 extends outwards to both sides of the first main body 110. In the present exemplary embodiment, the display unit 125 and the sound emission holes 173 of the first speaker 171 and the second speaker 172 may face frontwards from the portable terminal 200 in a single plane.

Referring to FIG. 7, an output direction of a sound may be adjusted by adjusting the angles of the first speaker 171 and the second speaker 172 extended outwards to both sides of the first main body 110. In the present exemplary embodiment, sounds can be output by the first speaker 171 and the second speaker 172 without interfering with each other, because the first speaker 171 and the second speaker 172 maintain a predetermined distance from each other.

Accordingly, a user may enjoy a stereo sound output by the first speaker 171 and the second speaker 172 extended to both sides of the first main body 110, for example watching a moving picture through the second display unit 125 or playing a game through the second display unit 125 and the input unit 117.

In the above described exemplary embodiments, examples of forming a receiving recess in a first main body for accommodating a speaker are disclosed. However, the receiving recess may alternatively be formed in a second main body. Further, examples of forming the speaker in a rectangular form are disclosed. However, the present invention is not limited thereto. For example, the speaker may be formed in a thin polygonal or elliptical plate form.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A portable terminal having a retractable speaker, comprising:
a main body having at least one display unit arranged on a first surface of the main body and a recess formed by a second surface of the main body;
a speaker; and
a hinge unit to connect the speaker to the main body, to extend the speaker outwards from the recess, and to retract the speaker into the recess,
wherein the speaker outputs a sound outwards from the first surface of the main body when extended.

2. The portable terminal of claim 1, wherein the speaker rotates about an axis of the hinge unit when extended.

3. The portable terminal of claim 2, wherein the hinge unit comprises:
a first hinge shaft arranged at an edge of the recess; and
a hinge body having one end connected to the speaker, and the opposite end rotatably connected to the first hinge shaft.

4. The portable terminal of claim 3, wherein the hinge unit further comprises a second hinge shaft having one end connected to the speaker and the opposite end rotatably connected to the hinge body to rotate the speaker.

5. The portable terminal of claim 4, wherein the speaker rotates about the first hinge shaft from the retracted state within the recess, to an extended state outside of the recess through an angle of at least 180 degrees.

6. The portable terminal of claim 5, wherein the speaker function is switched on if the speaker is extended from the recess, and switched off if the speaker is retracted into the recess.

7. The portable terminal of claim 5, wherein the speaker comprises:
a case having a plurality of sound emission holes formed on the case surface facing outwards from the main body, the speaker being retracted into the recess; and
a sound output unit arranged in the case to output a sound through the sound emission holes.

8. The portable terminal of claim 7, wherein two speakers are arranged at opposite edges of the recess.

9. The portable terminal of claim 8, wherein at least one of the two speakers has a cutout portion formed between the surface facing the recess and the surface facing outwards from the main body, the speaker being retracted into the recess.

10. The portable terminal of claim 1, wherein the main body is one of a swivel type, a bar type, a folder type, a slide type, and a flip type.

11. The portable terminal of claim 9, wherein the main body comprises:
a first main body having the recess; and
a second main body rotatably connected to the first main body and having a display unit arranged on a surface facing a surface of the first main body opposite to the surface having the recess.

12. The portable terminal of claim 11, wherein the second main body comprises:
a connecting part rotatably connected to the first main body; and
a switching unit rotatably connected to a surface of the connecting part facing a surface of the first main body, and having a display unit arranged on a surface of the switching unit facing the surface of the first main body.

13. A portable terminal having a sliding type retractable speaker, comprising:
a main body having a display unit arranged on a first surface and recesses formed at both sides of the main body adjacent to the first surface;
two speakers arranged individually in the recesses for outputting a sound outwards from the first surface; and
a hinge unit connected to each speaker to retract the speaker into the recess and to extend the speaker outwards from the recess.

14. The portable terminal of claim 13, wherein the main body has a guide recess formed in a second surface opposite to the first surface so that the recess is connected to the second surface, and wherein the hinge unit has a hinge shaft connected to a side of the speaker and a lever connected to the hinge shaft through the guide recess to retract the speaker into the recess and to extend the speaker outwards from the recess.

15. The portable terminal of claim 14, wherein the speaker rotates about the axis of the hinge shaft in a state that the speaker is extended outwards from the recess.

16. The portable terminal of claim 15, wherein the speaker comprises:
a case having a plurality of sound emission holes formed on its surface facing in the same direction as the first surface of the main body; and
a sound output unit installed in the case to output a sound through the sound emission holes.

17. The portable terminal of claim 13, wherein the main body is one of a swivel type, a bar type, a folder type, a slide type, and a flip type.
